(19) United States
(12) Patent Application Publication
(10) Pub. No.: US 2026/0138497 A1
(43) Pub. Date: May 21, 2026

(54) POWER MANAGEMENT SYSTEM FOR VEHICLE

(71) Applicant: TOYOTA JIDOSHA KABUSHIKI KAISHA, Toyota-shi (JP)

(72) Inventor: Toshiyuki MAEGAITO, Toyota-shi (JP)

(73) Assignee: TOYOTA JIDOSHA KABUSHIKI KAISHA, Toyota-shi (JP)

(21) Appl. No.: 19/349,174

(22) Filed: Oct. 3, 2025

(30) Foreign Application Priority Data
Nov. 15, 2024 (JP) 2024-199898

(51) Int. Cl. B60L 58/20; B60L 53/53; B60L 53/57

(52) U.S. Cl. CPC B60L 58/20; B60L 53/53; B60L 53/57; B60L 2210/10; B60L 2270/40

(57) ABSTRACT

A power management system for a vehicle includes a first processing unit configured to determine whether an instruction for software update of the vehicle is given, a second processing unit configured to determine whether power control is being performed to charge an auxiliary battery mounted on the vehicle, and a third processing unit configured to, when the instruction for the software update is given while the power control is being performed, limit charging of the auxiliary battery until the software update is completed.

### CROSS-REFERENCE TO RELATED APPLICATION

This application claims priority to Japanese Patent Application No. 2024-199898 filed on November 15, 2024. The disclosure of the above-identified application, including the specification, drawings, and claims, is incorporated by reference herein in its entirety.

### BACKGROUND

### 1. Technical Field

The present disclosure relates to a power management system mounted on a vehicle.

### 2. Description of Related Art

Japanese Unexamined Patent Application Publication No. 2022-160928 (JP 2022-160928 A) discloses an in-vehicle system that can perform software update by the over-the-air (OTA) technology. It is described that, in a case where a battery voltage drops to a predetermined value after the start of software update, the in-vehicle system suspends the update when the update progress rate is low, and switches to a power-saving mode and continues the update when the progress rate is high.

### SUMMARY

In recent years, there has been a trend that auxiliary loads that operate while a vehicle is parked increase. As the auxiliary loads increase, electric power of an auxiliary battery that is consumed while the vehicle is parked also increases. The electric power of the auxiliary battery is consumed also when the vehicle is parked or transported for a long period, and when occupants frequently get into and out of the vehicle. To prevent the auxiliary battery from being depleted while the vehicle is parked, control may be performed to charge the auxiliary battery with electric power from a high-voltage battery (hereinafter referred to as "auxiliary power supply control").

When software update is performed by OTA etc. while the auxiliary power supply control is being performed, the auxiliary power supply control may forcibly be terminated due to a reset process after the update is completed, resulting in unintended power control behavior. Such unintended power control behavior may result in depletion of the auxiliary battery.

The present disclosure has been made in view of the above problem, and has an object to provide a power management system for a vehicle that can suppress unintended power control behavior when an instruction for software update is given while auxiliary power supply control is being performed.

To solve the above problem, one aspect of the disclosed technology is a power management system for a vehicle. The power management system includes: a first processing unit configured to determine whether an instruction for software update of the vehicle is given; a second processing unit configured to determine whether power control is being performed to charge an auxiliary battery mounted on the vehicle; and a third processing unit configured to, when the instruction for the software update is given while the power control is being performed, limit charging of the auxiliary battery until the software update is completed.

When an instruction for software update by OTA etc. is given while auxiliary power supply control is being performed, the power management system for the vehicle according to the present disclosure intentionally limits the charging of the auxiliary battery until the software update is completed. Thus, unintended power control behavior can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of a power management system according to an embodiment of the present disclosure and its peripheral components; and

FIG. 2 is a flowchart of a power control process to be performed by the power management system.

### DETAILED DESCRIPTION OF EMBODIMENTS

When an instruction for software update by OTA is issued while auxiliary power supply control is being performed to charge an auxiliary battery with electric power from a high-voltage battery, the power management system for a vehicle according to the present disclosure first terminates (suspends) the auxiliary power supply control and then performs the software update. This process avoids unintended termination of control and prevents malfunctions in the vehicle.

Hereinafter, an embodiment of the present disclosure will be described in detail with reference to the drawings.

### Embodiment

### Configuration

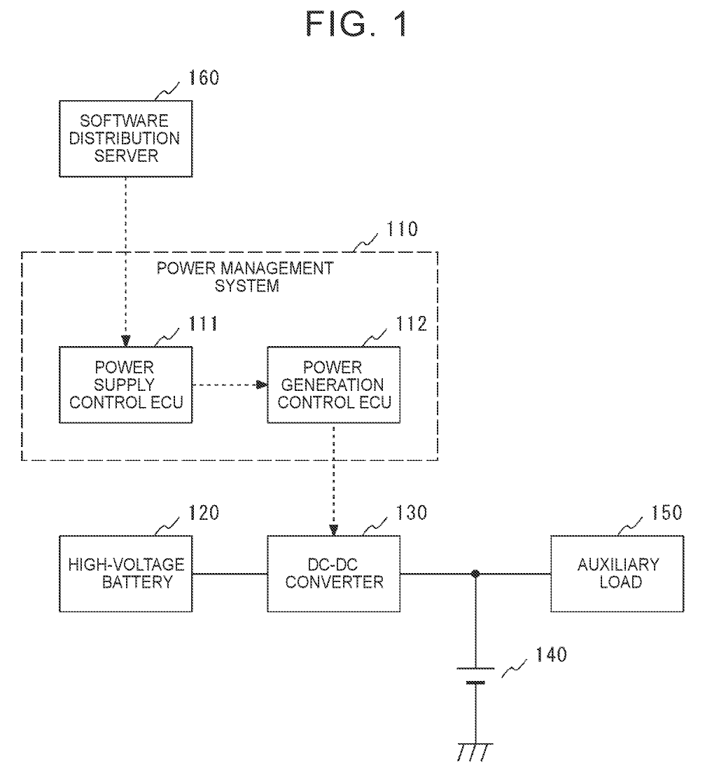

FIG. 1 is a functional block diagram of a power management system 110 according to the embodiment of the present disclosure and its peripheral components. The functional blocks shown in FIG. 1 include the power management system 110, a high-voltage battery 120, a DC-DC converter 130, an auxiliary battery 140, an auxiliary load 150, and a software distribution server 160.

In FIG. 1, power lines through which electric power is exchanged are indicated by continuous lines, and instructions related to control are indicated by dashed lines. The power management system 110, the high-voltage battery 120, the DC-DC converter 130, and the auxiliary battery 140 of the present embodiment are mounted on a vehicle such as a hybrid electric vehicle (HEV), a plug-in hybrid electric vehicle (PHEV), or a battery electric vehicle (BEV).

The high-voltage battery 120 is a secondary battery such as a lithium-ion battery that is chargeable and dischargeable. The high-voltage battery 120 is a battery for supplying electric power to a high-voltage system (not shown) including a so-called main engine related to vehicle traveling, such as an electric motor for traveling. The high-voltage battery 120 is connected to the auxiliary battery 140 and the auxiliary load 150 via the DC-DC converter 130 to charge the auxiliary battery 140 and supply electric power to the auxiliary load 150.

The DC-DC converter 130 is a power converter that can convert input electric power into electric power of a predetermined voltage and output the electric power. One end of the DC-DC converter 130 is connected to the high-voltage battery 120, and the other end of the DC-DC converter 130 is connected to the auxiliary battery 140 and the auxiliary load 150. The operation of the DC-DC converter 130 is controlled by instructions from a power generation control ECU 112 of the power management system 110.

The auxiliary battery 140 is a secondary battery such as a lithium-ion battery that is chargeable and dischargeable. The auxiliary battery 140 is a battery for supplying electric power to the auxiliary load 150. In general, the rated voltage of the auxiliary battery 140 is set lower than that of the high-voltage battery 120 (e.g., 12 V).

The auxiliary load 150 includes so-called auxiliary devices (not shown) such as equipment and devices that are not related to vehicle traveling. The auxiliary load 150 of the present embodiment includes, for example, a dashboard camera that consumes electric power of the auxiliary battery 140 when recording starts along with detection of an event while the vehicle is parked.

The power management system 110 is configured to control and manage electric power in a power supply system including the high-voltage battery 120, the DC-DC converter 130, and the auxiliary battery 140. The power management system 110 includes a power supply control ECU 111 and the power generation control ECU 112 as components (processing units) that perform processes for controlling and managing electric power.

The power supply control ECU 111 monitors the state of the auxiliary battery 140, and instructs the power generation control ECU 112 to start up (start-up instruction) when auxiliary power supply control is needed to charge the auxiliary battery 140 with electric power from the high-voltage battery 120. Following the start-up instruction, the power supply control ECU 111 instructs the power generation control ECU 112 to perform power supply from the high-voltage battery 120 to the auxiliary battery 140 (power supply instruction). When an instruction for software update is given from the software distribution server 160, the power supply control ECU 111 instructs the power generation control ECU 112 to suspend (temporarily stop) the auxiliary power supply control as necessary (power supply stop instruction).

The power generation control ECU 112 starts up in response to the start-up instruction from the power supply control ECU 111. In response to the power supply instruction from the power supply control ECU 111, the power generation control ECU 112 instructs the DC-DC converter 130 to transfer a predetermined amount of electric power from the high-voltage battery 120 to the auxiliary battery 140 (power generation instruction). In response to the power supply stop instruction from the power supply control ECU 111, the power generation control ECU 112 instructs the DC-DC converter 130 to stop the power transfer from the high-voltage battery 120 to the auxiliary battery 140 (power generation stop instruction).

The software distribution server 160 is a server that stores update data for updating software of an electronic control unit (ECU) etc. mounted on the vehicle. When vehicle software update is necessary, the software distribution server 160 instructs the power supply control ECU 111 of the power management system 110 to perform the update by OTA etc. (software update instruction). The software distribution server 160 distributes necessary update data to the vehicle (e.g., the power supply control ECU 111) when the update is performed.

### Control

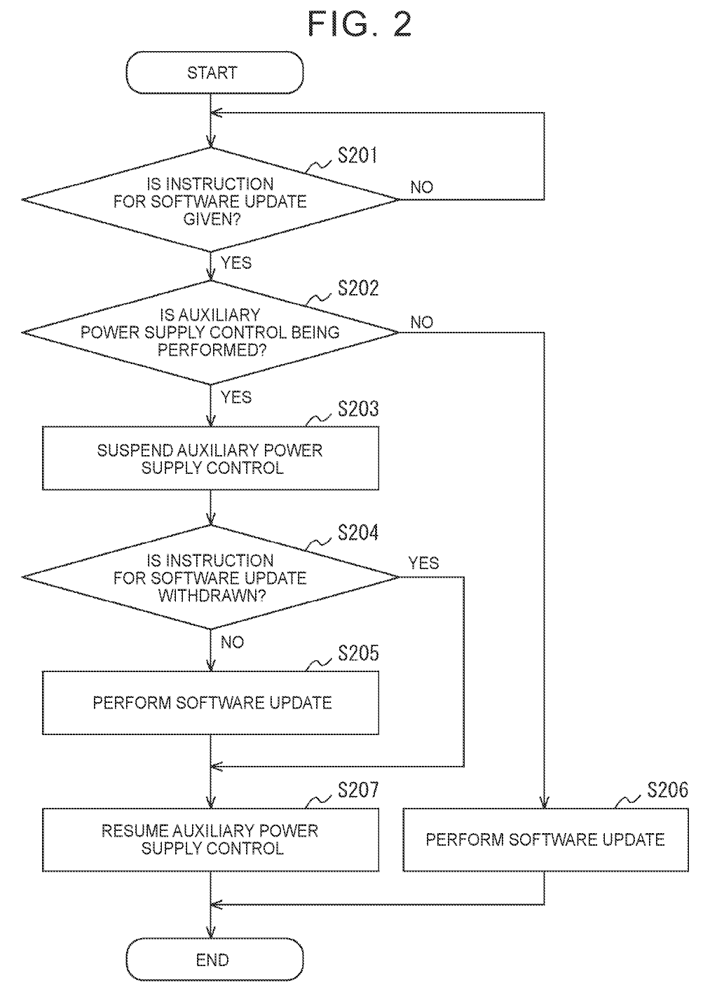

Next, control to be performed by the power management system 110 according to the embodiment of the present disclosure will be described with reference to FIG. 2. FIG. 2 is a flowchart illustrating the procedure of a power control process to be performed by the power management system 110. The power control illustrated in FIG. 2 is started, for example, when the vehicle is parked.

### Step S201

The power management system 110 determines whether an instruction for software update is given from the software distribution server 160 (first processing unit). When the instruction for software update is given (YES in step S201), the process proceeds to step S202.

### Step S202

The power management system 110 determines whether the auxiliary power supply control is being performed to charge the auxiliary battery 140 with electric power from the high-voltage battery 120 (second processing unit). When the auxiliary power supply control is being performed (YES in step S202), the process proceeds to step S203. When the auxiliary power supply control is not being performed (NO in step S202), the process proceeds to step S206.

### Step S203

The power management system 110 suspends (temporarily stops) the auxiliary power supply control that is being performed (third processing unit). Thus, it is possible to intentionally limit the power control for charging the auxiliary battery 140 with electric power from the high-voltage battery 120. When the auxiliary power supply control is suspended, the process proceeds to step S204.

### Step S204

The power management system 110 determines whether a new instruction to withdraw the instruction for software update is given from the software distribution server 160 (third processing unit). When the instruction for software update is withdrawn (YES in step S204), the process proceeds to step S207. When the instruction for software update is not withdrawn (NO in step S204), the process proceeds to step S205.

### Step S205

The power management system 110 performs a process for performing software update in an electronic control unit (ECU) etc. to be updated. When the software update is performed (from start to completion), the process proceeds to step S207.

### Step S206

The power management system 110 performs a process for performing software update in an electronic control unit (ECU) etc. to be updated. When the software update is performed (from start to completion), the power control ends.

### Step S207

The power management system 110 resumes (operates) the auxiliary power supply control that has been suspended (temporarily stopped) (third processing unit). Thus, it is possible to intentionally terminate the limitation on the power control for charging the auxiliary battery 140 with electric power from the high-voltage battery 120. When the auxiliary power supply control is resumed, the power control ends.

### Actions and Effects

As described above, when the instruction for software update is given while the auxiliary power supply control is being performed to charge the auxiliary battery 140 with electric power from the high-voltage battery 120, the power management system 110 according to the embodiment of the present disclosure suspends the auxiliary power supply control until the software update is completed.

By this control, unintended behavior of the auxiliary power supply control (forcible termination etc.) can be suppressed when the instruction for software update by OTA etc. is given while the auxiliary power supply control is being performed.

Although the embodiment of the disclosed technology has been described above, the present disclosure can be regarded not only as the power management system but also as a method to be performed by the power management system, a program for the method, a non-transitory computer-readable storage medium storing the program, and a vehicle including the power management system.

The power management system of the present disclosure can be used in vehicles etc. including a power supply system including a high-voltage battery, a DC-DC converter, and an auxiliary battery.

What is claimed is:

1. A power management system for a vehicle, the power management system comprising:
a first processing unit configured to determine whether an instruction for software update of the vehicle is given;
a second processing unit configured to determine whether power control is being performed to charge an auxiliary battery mounted on the vehicle; and
a third processing unit configured to, when the instruction for the software update is given while the power control is being performed, limit charging of the auxiliary battery until the software update is completed.

2. The power management system for the vehicle according to claim 1, wherein:
the second processing unit is configured to determine whether auxiliary power supply control is being performed as the power control to charge the auxiliary battery with electric power from a high-voltage battery mounted on the vehicle; and
the third processing unit is configured to, when the instruction for the software update is given while the auxiliary power supply control is being performed, suspend the auxiliary power supply control until the software update is completed.

3. The power management system for the vehicle according to claim 2, wherein the third processing unit is configured to, when the instruction for the software update is withdrawn, resume the auxiliary power supply control that has been suspended.
